(19) United States
(12) Patent Application Publication
(10) Pub. No.: US 2025/0371287 A1
(43) Pub. Date: Dec. 4, 2025

(54) METHODS AND SYSTEMS FOR IMPROVED NATURAL LANGUAGE PROCESSING AND GENERATION OF INSIGHTS

(71) Applicant: QlikTech International AB, Lund (SE)

(72) Inventors: Nasser Bumpus, Boston, MA (US); Yvonne Hederg, Malmo (SE); José Díaz López, Lund (SE); Steven Pressland, Borough Green (GB)

(21) Appl. No.: 19/226,358

(22) Filed: Jun. 3, 2025

Related U.S. Application Data
(60) Provisional application No. 63/655,235, filed on Jun. 3, 2024.

(51) Int. Cl. G06F 40/40; G06F 3/04842

(52) U.S. Cl. CPC G06F 40/40; G06F 3/04842

(57) ABSTRACT

Methods and systems for improved natural language processing and generation of insights are described herein. Aspects of machine learning and natural language processing may be employed to interpret user queries and provide insights, recommendations, and visualizations. The system employs large language models and machine learning services to enhance the natural language interaction between users and their analytics.

### CROSS-REFERENCE TO RELATED PATENT APPLICATION

This application claims priority to U.S. Prov. App. No. 63/655,235, filed on Jun. 3, 2024, the entirety of which is incorporated by reference herein.

### BACKGROUND

Natural Language Processing (NLP) and Machine Learning (ML) technologies have been increasingly used to enhance data analysis and visualizations. These technologies enable users to interact with data analytics platforms using natural language queries, which are interpreted to generate relevant insights and visualizations. These and other considerations are described herein.

### SUMMARY

It is to be understood that both the following general description and the following detailed description are exemplary and explanatory only and are not restrictive. The present disclosure relates to methods and systems for improving natural language processing and generating insights. The system may include a natural language assistant within an analytics platform. The assistant may use machine learning and natural language processing to provide automated insights, recommendations, and visualizations based on user queries. The system may use large language models and machine learning services to improve the natural language interaction between end users and their analytics. It may use prompt engineering to improve the language model's response. The system may also include the latest narrative templates as guides within the prompts to increase the likelihood that the language model will return the expected results.

The system may also use new and improved narrative templates, which may be supplemented with aggregations and/or hypercube definitions from an associative engine. A visualization related to the user's query and/or the corresponding data model may also (or alternatively) be provided with the prompt to the language model for the purposes of adding additional context, improved language semantics, net new observations, and creating a more human-like tone and structure for an end user.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system, according to aspects of the present disclosure.

FIG. 1B shows an example system, according to aspects of the present disclosure.

FIG. 2 shows an example user interface, according to aspects of the present disclosure.

FIG. 3 shows an example sequence diagram, according to aspects of the present disclosure.

FIG. 4 shows example elements related to insight generation, according to aspects of the present disclosure.

FIG. 5 shows an example system, according to aspects of the present disclosure.

FIG. 6 shows a flowchart for an example method, according to aspects of the present disclosure.

FIG. 7 shows a flowchart for an example method, according to aspects of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The present disclosure relates to methods and systems for enhancing data analysis and visualization using artificial intelligence (AI) and machine learning (ML) technologies. More specifically, the disclosure provides a system that employs a natural language assistant within an analytics platform to facilitate user interaction and generate insights from data. The system combines aspects of ML and natural language processing (NLP) techniques to interpret user queries, provide automated insights, and generate visualizations based on the user's data. The system utilizes large language models (LLMs) and ML services to improve the natural language interaction between end users and their analytics. It employs prompt engineering to enhance the LLM's response and includes the latest narrative templates as guides within the prompts to increase the likelihood of obtaining the expected results.

Furthermore, the system incorporates new and improved narrative templates, which may be supplemented with aggregations and/or hypercube definitions from an associative engine. A visualization related to the user's query and their corresponding data model(s) may also (or alternatively) be provided with the prompt to the LLM for the purposes of adding additional context, improved language semantics, net new observations, and creating a more human-like tone and structure for an end user.

The system improves upon approaches that rely on deterministic, template-based responses. Unlike conventional systems that generate rigid outputs by matching user queries to predefined analytic templates and populating them with relevant figures, the present system transforms these templates into prompt components that guide rather than dictate the output. This approach enables the generation of more flexible, contextually enriched insights that maintain factual accuracy while providing natural language fluency and adaptability to nuanced contexts.

The natural language assistant operates in conjunction with an in-memory associative analytics engine that provides real-time access to comprehensive data contexts. This associative engine differs fundamentally from SQL-based analytics systems by maintaining awareness of both selected and excluded data values, enabling the discovery of insights that traditional query-based tools often overlook. The engine's ability to perform sub-second data retrievals and maintain global associative indices of all values across tables ensures that the LLM receives rich, authoritative data context for generating accurate and relevant responses.

Furthermore, the system incorporates new and improved narrative templates, which may be supplemented with aggregations and/or hypercube definitions from an associative engine. These templates serve as building blocks within LLM prompts rather than as final output generators, allowing for dynamic narrative construction that combines template-derived factual content with the LLM's natural language generation capabilities. A visualization related to the user's query and their corresponding data model(s) may also (or alternatively) be provided with the prompt to the LLM for the purposes of adding additional context, improved language semantics, net new observations, and creating a more human-like tone and structure for an end user.

The system may employ a two-stage LLM processing approach where a secondary LLM first processes templates and metadata to produce structured draft findings, including factual observations and visualization recommendations. These draft findings then become part of an enhanced prompt for a primary LLM that generates the final polished insight with appropriate narrative flow and contextual relevance. This cooperative generation approach ensures both factual correctness through grounding in actual data and engaging presentation through advanced natural language capabilities.

The system also supports insight generation triggered by visual interactions, such as chart selections or dashboard elements, not just textual queries. When users interact with visualizations, the system captures chart metadata, underlying data points, and current analytical context to generate explanatory narratives about selected elements. This capability transforms static visualizations into interactive interfaces where users can obtain immediate explanations of patterns, anomalies, or relationships simply by selecting visual elements of interest.

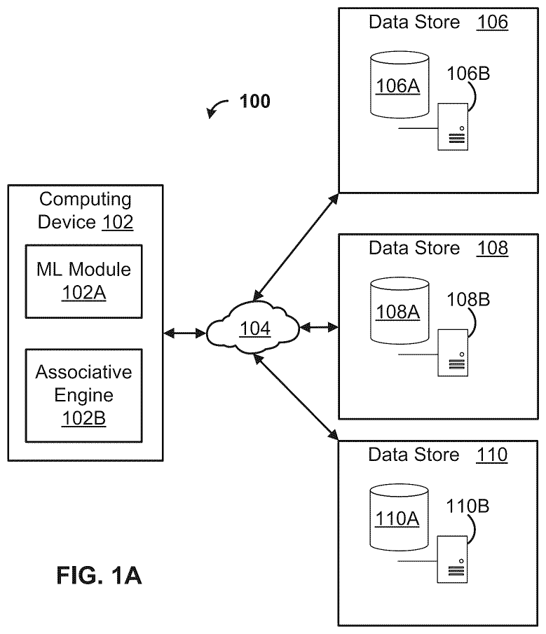

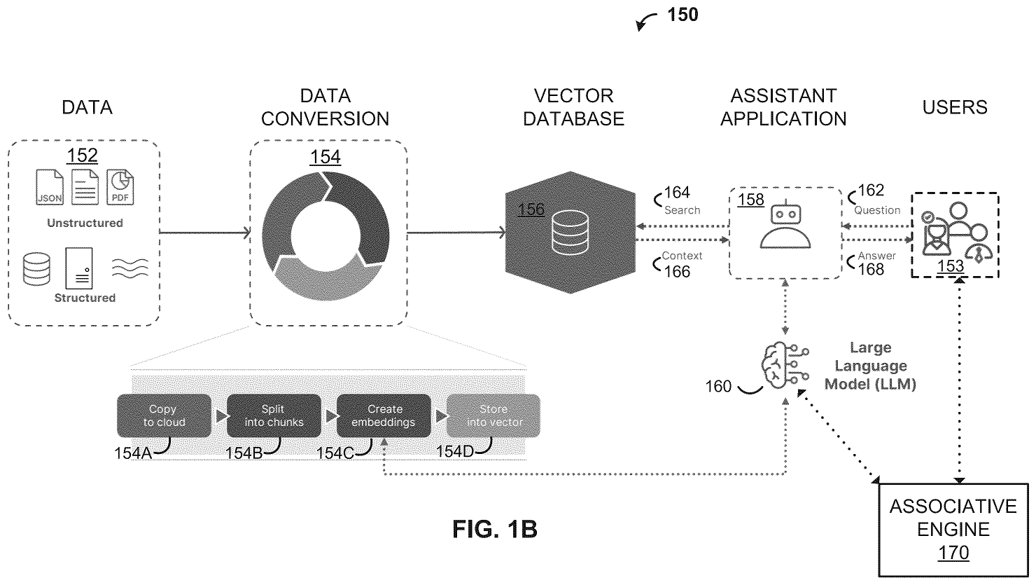

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For case of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by one or more Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For case of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160, such as a primary LLM and a secondary LLM as further described herein. Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

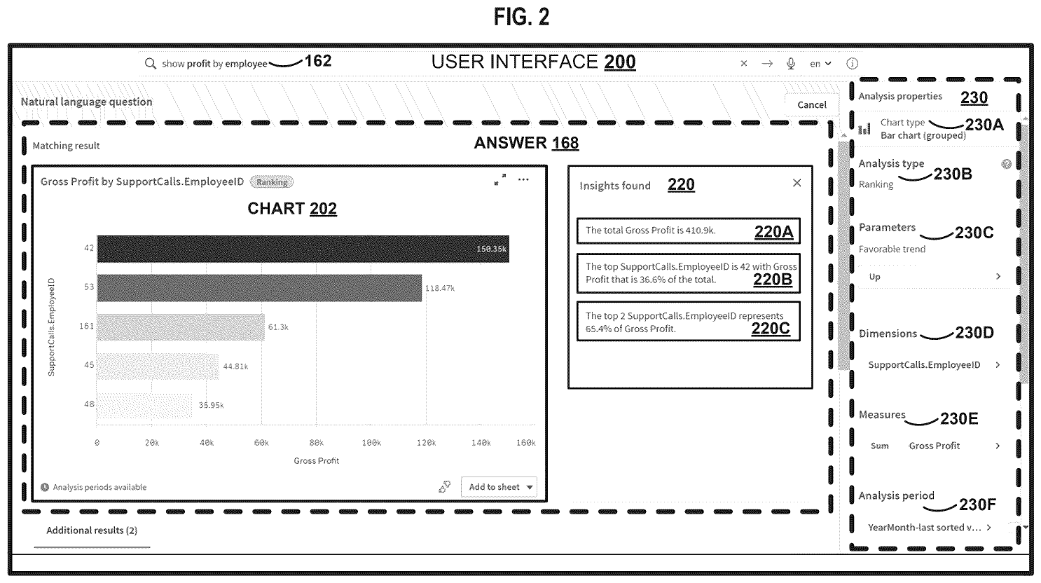

Turning now to FIG. 2, an example user interface 200 is shown. The user interface 200 may provide an interactive environment for users to engage with the natural language processing and insight generation capabilities of the systems described herein. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. The question 162 may be processed by the assistant application 158 as described in relation to FIG. 1B. The input field may support various types of queries, ranging from simple data requests to complex analytical questions. Users may ask questions such as “What were the top products last quarter?” or “Show me sales trends by region.” The system may interpret these natural language inputs and convert them into appropriate data operations.

The user interface 200 may also display an answer 168 in response to the user's question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170. The natural language response may be tailored to the user's specific query and may include relevant details, comparisons, and observations about the data. The answer 168 may comprise natural language text that provides insights, explanations, or responses to the user's query.

A chart 202 may be displayed within the user interface 200. The chart 202 may provide a visual representation of data relevant to the user's query or the current analytical context. The chart 202 may be generated based on data retrieved from the associative engine 170 and/or from the vector database 156. The chart 202 may be interactive, allowing users to click on specific elements to request additional insights or explanations. The visualization may be automatically selected based on the type of analysis being performed and the nature of the data being displayed. The chart 202 may be a visual representation of data relevant to the user's query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 202, the user's query, and other contextual information. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. The analysis properties 230 may be derived from the contextual metadata provided by the associative engine 170 and may include information such as current selection states, hypercube data, statistical measures, and comparative values.

The analysis properties 230 may serve multiple purposes within the system. They may provide the factual foundation for the natural language insights, ensuring that the generated text is grounded in actual data rather than hallucinated information. The properties may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 202 to request explanations or additional insights about specific data points. The system may respond to these interactions by generating new insights or by providing more detailed analysis of the selected elements. This interactive capability may be supported by the associative engine 170. The associative engine 170 can quickly retrieve relevant contextual information about any selected data point or visualization element. The chart 202 and the insights 220 may be dynamically updated based on user interactions. For example, if a user selects a particular bar in the chart 202, the system 150 may generate new insights specific to that selection. This interactive capability may be facilitated by the associative engine 170. The associative engine 170 can quickly retrieve and analyze relevant data based on user selections.

The user interface 200 may also include additional interactive elements not explicitly shown in FIG. 2. These may include filters, dropdown menus, or buttons that allow users to refine their queries, change data views, or access additional features of the system 150. The integration of natural language input, visual data representation, and AI-generated insights in a single interface demonstrates the system's capability to provide a comprehensive analytical experience. This approach may allow users of varying technical expertise to gain valuable insights from complex data sets.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations.

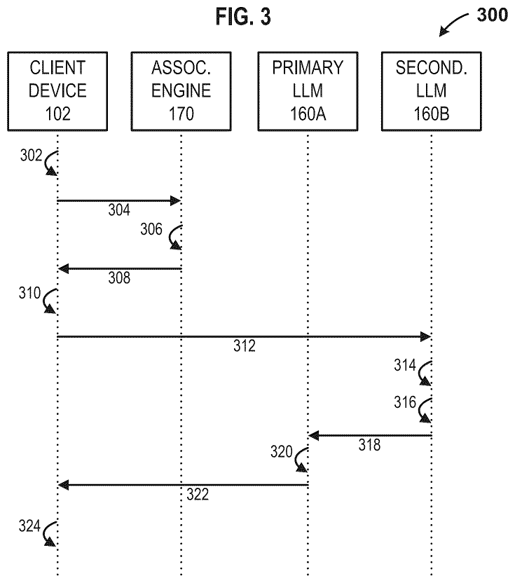

Turning now to FIG. 3, a sequence diagram 300 is shown. The sequence diagram 300 may illustrate the communication flow and interaction patterns between different components of the system for generating insights in an associative analytics environment. The sequence diagram 300 may show how the various system components work together to process user queries and generate comprehensive responses. The responses may include both natural language insights and appropriate visualizations.

The sequence diagram 300 may involve four main system components: the computing device 102, the associative engine 170, a primary LLM 160A, and a secondary LLM 160B. The primary LLM 160A and secondary LLM 160B may represent components of the large language model(s) 160 described in FIG. 1B.

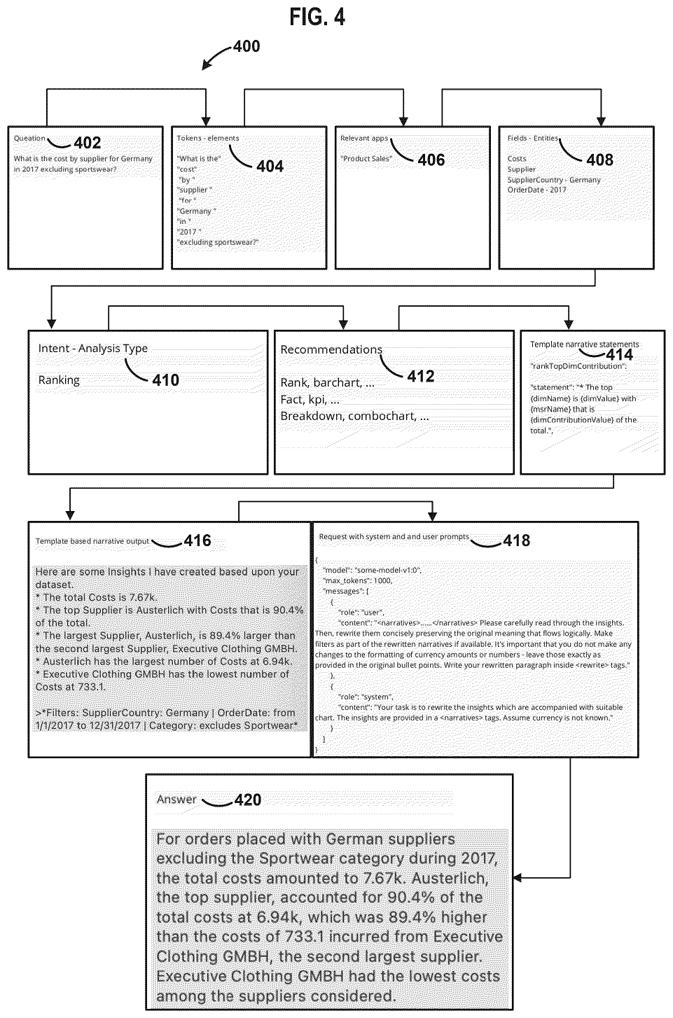

The sequence may begin with step 302. In step 302, the computing device 102 may receive a user query or chart interaction requesting insights about specific data. This step may correspond to the question 402 shown in FIG. 4. The user query may be a natural language question entered through the user interface 200. The user query may alternatively be an interaction with a chart or visualization element. The computing device 102 may process this initial input and determine what type of analytical response is needed. The query may be parsed to extract linguistic elements. These linguistic elements may correspond to the tokens 404 shown in FIG. 4. The tokens 404 may be analyzed to understand the intent, scope, and specific requirements of the user's request. Natural language processing techniques may be applied to identify entities, relationships, and analytical requirements embedded in the user's query.

In step 304, the computing device 102 may send a request to the associative engine 170 for contextual metadata extraction. This request may initiate the process of gathering all relevant information about the current analytical context. The associative engine 170 may be queried to provide information about the current state of the data model, any active selections or filters, and the relationships between different data elements. This step may ensure that the subsequent analysis is grounded in the actual state of the user's analytical session. The system may simultaneously identify relevant apps 406 that contain pertinent data for the analysis. The relevant apps 406 may correspond to the analytics applications described earlier. These applications may contain data models, visualizations, and other analytical resources. The system may determine which apps are most relevant to the user's query based on the entities and concepts identified in the question 402.

Step 306 may involve the associative engine 170 processing the request and retrieving the current selection state, hypercube data, and data model relationships. The associative engine 170 may leverage its in-memory data structures to quickly access this information. The current selection state may include any filters or selections that the user has applied to the data. Hypercube data may include the specific data subsets that are relevant to the user's query. Data model relationships may provide information about how different tables and fields are connected within the analytical model. The system may also extract fields/entities 408 from the data model. The fields/entities 408 may be associated with the user's query. The fields/entities 408 may represent the specific data elements, dimensions, and measures that are relevant to answering the user's question. This extraction may be performed by analyzing the semantic content of the query and mapping it to the available data schema.

In step 308, the associative engine 170 may return the requested data, including aggregations, filters, and dimensional information, back to the computing device 102. This data may form the foundation for the subsequent insight generation process. The returned information may include not only the data that matches the current selections but also information about excluded or unrelated data values. This comprehensive view may enable the system to generate insights that go beyond simple query results. The insights generated, therefore, may include observations about data that is not immediately visible in the current view.

Following the data retrieval, step 310 may show the computing device 102 processing the received data and generating contextual metadata. This processing may involve organizing the raw data into a format suitable for prompt construction. The contextual metadata may include current selections, excluded values, statistical summaries, and other relevant analytical context. This step may correspond to the processing of tokens 404, relevant apps 406, and fields/entities 408 shown in FIG. 4. The system may determine what type of analytical approach is most appropriate for the user's query and the available data. This determination may correspond to the intent-analysis type 410 shown in FIG. 4. The system may classify the query into categories such as trend analysis, comparison, ranking, correlation, or outlier detection.

In step 312, the computing device 102 may send the contextual metadata and data summary to the secondary LLM 160B. This transmission may initiate the AI-powered insight generation process. The secondary LLM 160B may receive not only the raw data but also the processed contextual information. The processed contextual information may provide meaning and structure to that data. This contextual enrichment may enable the language model to generate more accurate and relevant insights.

Step 314 shows the secondary LLM 160B performing analysis and constructing an initial prompt containing the user query, contextual metadata, and relevant template patterns. This step may correspond to the intent-analysis type 410 and template narrative statements 414 shown in FIG. 4. The secondary LLM 160B may analyze the provided context to determine what type of analytical approach is most appropriate for the user's query. At step 316, the prompt construction may involve combining the factual data with structural guidance from templates to create a comprehensive input for the next stage of processing. The template narrative statements 414 may provide structured narrative components that can be used to construct the insight response. These statements may represent pre-defined patterns for expressing different types of analytical findings. The template narrative statements 414 may ensure that the generated insights follow logical structures and include appropriate analytical language.

The secondary LLM 160B may focus on extracting facts, identifying patterns, and suggesting appropriate visualizations for the data. This step may correspond to the template-based narrative output 416 and visualization recommendation(s) 412 shown in FIG. 4. The draft findings may include factual observations, statistical measures, and recommendations for how the insights should be presented visually. The template-based narrative output 416 may create preliminary narrative content based on the identified patterns and templates. The visualization recommendation(s) 412 may suggest appropriate chart types or visual representations for the identified analysis type. The recommendations may consider factors such as the type of data being analyzed, the number of dimensions and measures involved, and the most effective way to communicate the analytical findings visually.

In step 318, the secondary LLM 160B may return these preliminary results, sending draft findings including insights and recommended chart specifications back to the primary LLM 160A. These draft findings may serve as the factual foundation for the final insight generation at step 320. The visualization recommendations may specify the type of chart or graph that would best illustrate the findings. The recommendations may include details about how the data should be presented. As part of step 320, the primary LLM 160A may create an enhanced prompt by combining the original context, draft findings, and narrative instructions. This enhanced prompt may represent the culmination of the contextual gathering and preliminary analysis phases. The primary LLM 160A may integrate all available information to create a comprehensive prompt. The comprehensive prompt may guide the final insight generation process. This step may correspond to the engineered prompt 418 shown in FIG. 4. The engineered prompt 418 may incorporate the data context, visualization recommendations, and narrative elements to guide the generation process. All the gathered contextual information, analysis results, and template outputs may be combined into a structured prompt for the language model.

The enhanced, structured prompt may include instructions for creating natural language narratives that are both accurate and engaging. The prompt may specify the tone, style, and level of detail appropriate for the intended audience. As part of step 320, the primary LLM 160A may generate a complete natural language narrative and refined visualization specifications using the provided context. This step may correspond to the answer 420 shown in FIG. 4. The answer 420 may combine natural language narrative with appropriate visualizations based on the processed information and AI-generated content. The answer 420 may represent the culmination of the entire insight generation process. The answer 420 may provide users with comprehensive analytical responses that address their original queries while offering additional contextual information and visual representations.

The sequence may continue to step 322 where the primary LLM 160A sends the final insight response/answer 420, including both narrative text and accompanying visualizations for the user, to the client device 102. In the final step 324, the client device 102 may output the generated insights (e.g., via the user interface 200). The presentation may ensure that users receive a comprehensive analytical response that addresses their original query while providing additional contextual information and visual representations. Overall, the sequence 300 may ensure that the final output is both factually accurate and presented in a natural, engaging manner. The integration of template-based approaches with advanced language model capabilities may enable the system to generate insights that are superior to purely deterministic or purely AI-generated approaches.

This multi-step process may involve both the associative engine and multiple LLMs. The process may allow the system to generate insights that are not only accurate and data-driven but also contextually relevant and expressed in natural language. The use of two LLMs in this process may allow for more nuanced and comprehensive insights than a single LLM approach. The primary LLM may provide high-level reasoning. The secondary LLM may provide detailed analysis and narrative generation. The sequence diagram 300 may illustrate how the system combines the speed and data processing capabilities of the associative engine with the natural language understanding and generation capabilities of large language models. This combination may allow for the creation of a system that can provide rapid, contextually aware, and easily understandable insights from complex data sets.

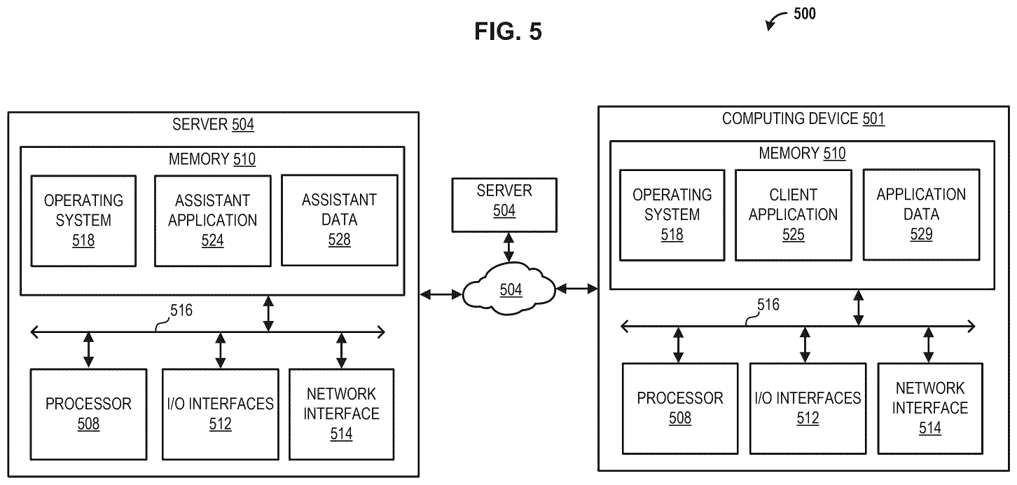

The present methods and systems may be computer-implemented. FIG. 5 shows a block diagram depicting a system/environment 500 comprising non-limiting examples of a computing device 501 and a server 502 connected through a network 504. Either of the computing device 501 or the server 502 may be a computing device, such as any of the devices of the system 100 shown in FIG. 1A. In an aspect, some or all steps of any described method may be performed on a computing device as described herein. The computing device 501 may comprise one or multiple computers configured to store application data 529, and/or the like. The server 502 may comprise one or multiple computers configured to store assistant data 529. Multiple servers 502 may communicate with the computing device 501 via the through the network 504.

The computing device 501 and the server 502 may be a digital computer that, in terms of hardware architecture, generally includes a processor 508, system memory 510, input/output (I/O) interfaces 512, and network interfaces 514. These components (508, 510, 512, and 514) are communicatively coupled via a local interface 516. The local interface 516 may be, for example, but not limited to, one or more buses or other wired or wireless connections, as is known in the art. The local interface 516 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 508 may be a hardware device for executing software, particularly that stored in system memory 510. The processor 508 may be any custom made or commercially available processor, a central processing unit (CPU), an auxiliary processor among several processors associated with the computing device 501 and the server 502, a semiconductor-based microprocessor (in the form of a microchip or chip set), or generally any device for executing software instructions. When the computing device 501 and/or the server 502 is in operation, the processor 508 may execute software stored within the system memory 510, to communicate data to and from the system memory 510, and to generally control operations of the computing device 501 and the server 502 pursuant to the software.

The I/O interfaces 512 may be used to receive user input from, and/or for providing system output to, one or more devices or components. User input may be provided via, for example, a keyboard and/or a mouse. System output may be provided via a display device and a printer (not shown). I/O interfaces 512 may include, for example, a serial port, a parallel port, a Small Computer System Interface (SCSI), an infrared (IR) interface, a radio frequency (RF) interface, and/or a universal serial bus (USB) interface.

The network interface 514 may be used to transmit and receive from the computing device 501 and/or the server 502 on the network 504. The network interface 514 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 514 may include address, control, and/or data connections to enable appropriate communications on the network 504.

The system memory 510 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 510 may incorporate electronic, magnetic, optical, and/or other types of storage media. Note that the system memory 510 may have a distributed architecture, where various components are situated remote from one another, but may be accessed by the processor 508.

The software in system memory 510 may include one or more software programs, each of which comprises an ordered listing of executable instructions for implementing logical functions. In the example of FIG. 5, the software in the system memory 510 of the computing device 501 may comprise the application data 529, the client application 525, and a suitable operating system (O/S) 518. In the example of FIG. 5, the software in the system memory 510 of the server 502 may comprise the assistant data 529, the assistant application 524, and a suitable operating system (O/S) 518. The operating system 518 essentially controls the execution of other computer programs and provides scheduling, input-output control, file and data management, memory management, and communication control and related services.

For purposes of illustration, application programs and other executable program components such as the operating system 518 are shown herein as discrete blocks, although it is recognized that such programs and components may reside at various times in different storage components of the computing device 501 and/or the server 502. An implementation of the system/environment 500 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

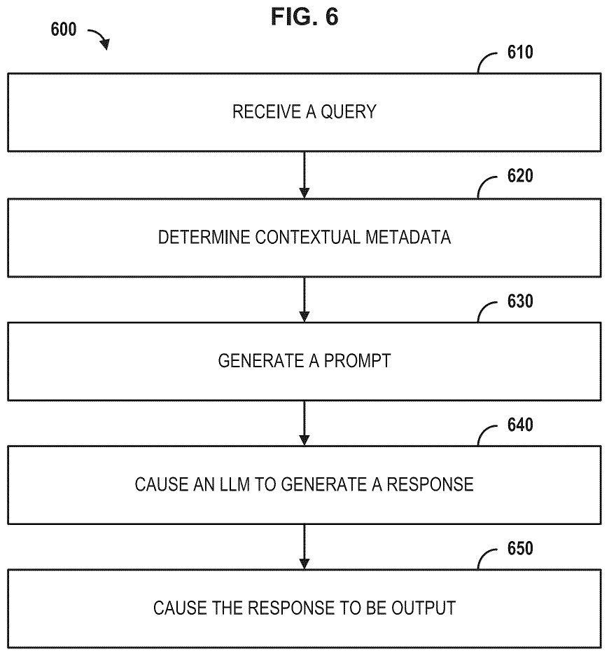

Turning now to FIG. 6, a method 600 for generating insights using an associative engine and large language models is shown. The method 600 may represent a comprehensive approach to transforming user queries into contextually-aware insights that combine the analytical power of associative engines with the generative capabilities of large language models.

The method 600 may begin with step 610, where the client device 102 receives a query from a user. This step may correspond to receiving a natural language query or a selection of a chart element. The query reception may occur through various interfaces, including the user interface 200 shown in FIG. 2. The query may be a natural language question such as “What were the top products last quarter?” or it may be an interactive selection of a visualization element where the user clicks on a chart or graph to request an explanation. The system may be configured to handle both explicit textual queries and implicit queries generated through user interactions with visual elements.

The query reception process may involve parsing and initial processing of the user input. For natural language queries, this may include tokenization, entity recognition, and intent classification. For chart element selections, this may involve identifying the specific data points, dimensions, and measures associated with the selected element. The system may also capture contextual information about the user's current analytical session, including any active filters, selections, or previous queries that may be relevant to the current request.

The method 600 may support various types of user interactions beyond simple text queries. Users may interact with charts by clicking on specific bars, lines, or data points to request explanations about those elements. The system may interpret these interactions as implicit queries about the selected data. For example, if a user clicks on a bar in a sales chart representing a particular month, the system may interpret this as a query about what made that month's performance notable or different from other months.

The method 600 may then proceed to step 620, where contextual metadata is determined based on the received query and the current state of the associative engine. The contextual metadata may include at least one of current selection state, hypercube data, data model relationships, or user interaction history. The current selection state may include information about any filters or selections that the user has applied to the data. This may include specific regions, products, time periods, or other dimensional values that are currently selected or excluded. The associative engine may provide comprehensive information about both selected and excluded values, enabling the system to generate insights that consider the full context of the user's analytical focus.

Hypercube data may represent the specific data subsets that are relevant to the user's query. The associative engine may quickly generate these data cubes by applying the current selections and filters to the underlying data model. The hypercube data may include aggregated values, dimensional breakdowns, and statistical measures that are pertinent to the analysis. The associative engine's in-memory architecture may enable sub-second response times for retrieving this contextual metadata.

Data model relationships may provide information about how different tables and fields in the data model are connected. This information may be crucial for understanding the context of the data and for generating accurate insights that take into account the full complexity of the data model. In addition to these elements, the contextual metadata may also include information about excluded data values. These are data values that are not associated with the current user selections but may still be relevant for providing comprehensive analytical context. For example, if a user has selected to view data for a specific region, the system may also consider data from other regions to provide a more complete picture or to highlight any significant differences.

The method 600 may then move to step 630, where a prompt is generated using the contextual metadata and relevant template components. This prompt may be designed to guide a large language model in generating a response that is both accurate and contextually relevant. The prompt generation process may involve several components. First, it may incorporate the contextual metadata determined in the previous step. This ensures that the LLM has access to all relevant information about the current state of the data and the user's query. Second, the prompt may include one or more insight templates. These templates may comprise narrative structure patterns and analytical logic rules that guide content generation. However, unlike in traditional template-based systems, these templates are not used to dictate the specific output format.

Instead, they are incorporated as components within the prompt, providing guidance to the LLM without constraining its output. For example, an insight template might provide a structure for comparing values across different categories, or for identifying trends over time. The LLM may use these templates as a starting point, but it has the flexibility to adapt and expand upon them based on the specific context of the user's query and the data. The prompt may also include instructions for the LLM about the desired tone, level of detail, and type of insights to focus on. These instructions may be tailored based on user preferences, the nature of the query, or the type of data being analyzed.

In step 640, the client device 102 causes a large language model (e.g., 160) to generate a response based on the constructed prompt. This step involves processing the prompt through the LLM to produce natural language narratives and analytical insights grounded in the actual data. The LLM used in this step may be a state-of-the-art model trained on a wide range of texts and capable of understanding and generating human-like text. It may be fine-tuned for the specific task of generating analytical insights and explanations. When processing the prompt, the LLM may perform several tasks. It may analyze the contextual metadata to understand the current state of the data and the user's query. It may use the insight templates provided in the prompt as a guide for structuring its response. And it may generate natural language text that explains the insights it has identified in a clear and coherent manner.

The response generated by the LLM may include several components. It may provide a direct answer to the user's query if one was posed. It may highlight key trends, patterns, or anomalies in the data. It may offer comparisons between different data points or categories. And it may suggest areas for further investigation or analysis. Importantly, the LLM's response is not limited to just repeating the facts present in the data. By leveraging its training on a wide range of texts, the LLM may be able to provide context, draw connections, or offer interpretations that go beyond what is explicitly stated in the data. However, it does this while remaining grounded in the factual information provided in the prompt, ensuring that its insights are relevant and accurate.

The method 600 concludes with step 650, where the generated response is output to the user interface. This step involves presenting the LLM-generated insights to the user in a clear and accessible format. The output may include natural language text that explains the insights identified by the LLM. For example, this text may be displayed in the answer field 168 of the user interface 200, as shown in FIG. 2.

In addition to the text, the output may also include visualizations that illustrate the insights. These visualizations may be similar to the chart 202, or they may be new visualizations generated based on the LLM's analysis. The system may use the visualization recommendations provided by the LLM to create these charts or graphs. The output may also include interactive elements that allow the user to explore the insights further. For example, there may be options to drill down into specific data points, to view alternative visualizations, or to ask follow-up questions.

The method 600 may be iterative, with the user able to ask follow-up questions or make new selections that trigger the process to begin again. Each iteration may build upon the context of previous interactions, allowing for a conversational and exploratory approach to data analysis. This may represent a significant advancement over traditional approaches to data analysis and insight generation. By combining the speed and data processing capabilities of an associative engine with the natural language understanding and generation capabilities of large language models, it may enable more intuitive, flexible, and powerful data analysis tools. The method 600 may allow users to interact with their data in natural language, asking questions and receiving insights in a conversational manner. This may make advanced data analysis more accessible to users who may not have specialized technical skills.

At the same time, by grounding the LLM's responses in actual data and contextual metadata provided by the associative engine, the method 600 may ensure that the insights generated are accurate and relevant. The use of templates as guidance rather than rigid structures may allow for more flexible and context-appropriate responses while still maintaining a coherent and logical structure. The ability to include information about excluded data values in the contextual metadata may allow for more comprehensive insights. For example, the system may be able to point out not just what is present in the selected data, but also what is notably absent, or how the selected data compares to excluded data. This may help users identify blind spots in their analysis or uncover unexpected patterns.

The method 600 may also be able to handle a wide range of query types. Users may ask specific questions about their data, request general insights, or interact with visualizations to trigger analysis. The flexibility of the LLM-based approach may allow the system to handle these varied inputs and generate appropriate responses. Moreover, the method 600 may be able to adapt its responses based on the user's level of expertise, the complexity of the data, or the specific context of the analysis. For example, it may provide more detailed technical explanations for expert users, or simpler, more high-level insights for novice users.

The use of large language models in this method may also allow for more nuanced and contextually aware responses. The LLM may be able to understand implied context, handle ambiguous queries, and generate responses that take into account broader knowledge beyond just the immediate data at hand. For example, if a user asks about sales trends, the LLM might not just report the numbers, but also offer possible explanations for the trends based on its broader knowledge. It might suggest checking for correlations with marketing campaigns, economic indicators, or seasonal patterns, even if these factors are not explicitly mentioned in the data.

The method 600 may also be able to generate insights that combine information from multiple parts of the data model. Because the associative engine understands the relationships between different tables and fields, and this information is included in the contextual metadata, the LLM may be able to draw connections and insights that span across different areas of the data. Another advantage is the ability to provide progressive disclosure of information. The initial response might provide a high-level summary of the key insights, but the user may be able to ask for more details on specific points, effectively drilling down into the analysis. This may allow users to start with a broad overview and then focus on the areas that are most interesting or relevant to them.

The method 600 may also support comparative analysis. If a user asks how current performance compares to past periods or to different segments of the business, the system may be able to quickly retrieve the relevant data via the associative engine and present a comparative analysis through the LLM. Furthermore, the method 600 may be able to handle hypothetical scenarios. A user might ask “What if” questions, and the system could use the associative engine to quickly recalculate metrics based on hypothetical changes, and then use the LLM to explain the potential impacts in natural language. The combination of fast data processing (via the associative engine) and natural language generation (via the LLM) may enable a more interactive and responsive analysis experience. Users may be able to explore their data through a series of questions and refinements, with each interaction providing new insights and prompting new avenues of investigation.

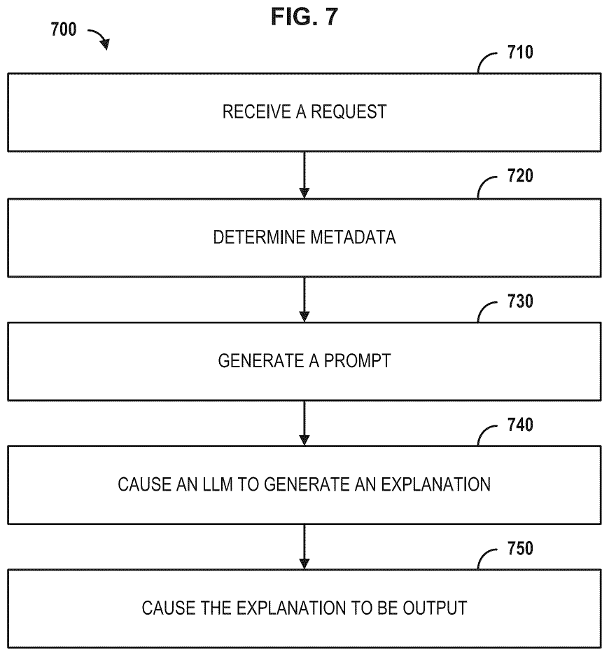

Turning now to FIG. 7, a flowchart for a method 700 is shown. The method 700 may be implemented by the client device 102, for example, to generate explanations using an associative engine and large language models. The method 700 may begin with step 710, where the client device 102 receives a request from a user. This request may be based on a user selection of a visualization element in a user interface. For example, a user might click on a specific bar in a bar chart, a data point in a scatter plot, or a segment of a pie chart. The visualization element may be part of a larger dashboard or analytics interface, such as the user interface 200 shown in FIG. 2. The request may not necessarily be a direct question. Instead, it may be an implicit request for insight generation about the selected visualization element. For instance, the user's action of selecting a particular data point may be interpreted by the system as a request to explain what's interesting or significant about that data point.

In step 720, the method 700 proceeds to determine metadata based on the received request and the current analytical context. This step is crucial for providing a comprehensive and contextually relevant explanation. The metadata determined in this step may include various types of information. It may comprise chart metadata, which could include details about the type of chart (e.g., bar chart, line graph, scatter plot), the data dimensions represented on each axis, and any color coding or other visual elements used in the chart. The metadata may also include underlying data from the associative engine. This could encompass the specific data points represented in the visualization, as well as related data that might not be directly visible in the chart but is relevant for providing a comprehensive explanation.

For example, if a user has selected a bar representing sales for a particular product in a specific month, the metadata might include not just the value of that data point, but also sales figures for other products, sales figures for other months, and perhaps even related data like marketing spend or customer demographics. The associative engine's ability to quickly retrieve and process this data is an example advantage of the system. It allows for the inclusion of a wide range of relevant information in the metadata, which can then be used to generate more insightful and comprehensive explanations.

The metadata may also include historical comparison data. This could involve looking at how the selected data point compares to historical trends or averages. For instance, if a user has selected a data point showing unusually high sales, the metadata might include information about average sales levels, allowing the system to quantify how unusual the selected data point is. Another important aspect of the metadata may be the current filters and selections applied in the analytics interface. This context is crucial for understanding what the user is currently focusing on and how the selected visualization element fits into their broader analysis.

The method 700 then moves to step 730, where a prompt is generated using the determined metadata and relevant contextual information. This prompt is designed to guide a large language model in generating an explanation that is both accurate and contextually relevant. The prompt may include several components. First, it may contain a structured representation of the chart metadata and underlying data. This could be formatted in a way that is easy for the LLM to process, such as a JSON structure or a series of key-value pairs. Second, the prompt may include template-based analytical findings. These templates may be pre-computed statistical analyses or trend identifications that are incorporated as factual components within the prompt. For example, a template might identify whether the selected data point is an outlier, or calculate the percentage difference between the selected value and the mean. The prompt may also include instructions for the LLM about the type of explanation desired. This could specify whether a high-level summary is needed, or a detailed breakdown of contributing factors. It might also indicate whether comparisons to other data points should be emphasized, or if the focus should be on explaining the selected point in isolation. Additionally, the prompt may include relevant business context or domain-specific information. This could help the LLM generate explanations that are not just statistically accurate, but also meaningful in the context of the business or field of study.

In step 740, the method 700 involves causing a large language model to generate an explanation based on the constructed prompt. This step is where the power of natural language processing is leveraged to turn raw data and analytical findings into a coherent, human-readable explanation. The LLM used in this step may be a state-of-the-art model capable of understanding complex prompts and generating nuanced, contextually appropriate text. It may be specifically fine-tuned for the task of generating analytical explanations.

When processing the prompt, the LLM may perform several tasks. It may analyze the structured data provided to understand the key features of the selected visualization element. It may use the template-based findings as a starting point for its explanation. And it may generate natural language text that explains the significance of the selected element in a clear and insightful manner. The explanation generated by the LLM may include several components. It may describe what the selected element represents in the context of the overall visualization. It may highlight how the selected element compares to other elements or to historical data. It may identify any unusual or noteworthy characteristics of the selected element.

Importantly, the LLM's explanation is not limited to just restating the facts present in the data. By leveraging its training on a wide range of texts, the LLM may be able to provide context, draw connections, or offer interpretations that go beyond what is explicitly stated in the data. However, it does this while remaining grounded in the factual information provided in the prompt, ensuring that its explanations are relevant and accurate. For example, if the selected element shows an unusual spike in sales, the LLM might not just report the numbers, but also suggest possible explanations based on its understanding of business dynamics. It might mention factors like seasonal trends, marketing campaigns, or external events that could potentially explain the spike. The LLM may also be able to tailor its language and level of detail based on cues in the prompt about the user's level of expertise or the context of the analysis. This allows for explanations that are appropriately sophisticated for expert users, while remaining accessible for novice users.

The method 700 concludes with step 750, where the explanation is caused to be output to a user interface (e.g., the user interface 200). This step involves presenting the LLM-generated explanation to the user in a clear and accessible format. The output may include natural language text that explains the significance of the selected visualization element. This text may be displayed in a dedicated area of the user interface, perhaps in a tooltip or a sidebar that appears when an element is selected.

In addition to the text, the output may also include additional visualizations that support or illustrate the explanation. These could be smaller charts or graphs that provide additional context or breakdowns of the data related to the selected element. The explanation may be interactive, allowing users to drill down into specific aspects of the explanation or to view the underlying data that supports particular claims. This interactivity can help users explore the insights further and verify the explanations provided. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, based on a user interaction with a user interface, a natural language query or a selection of a chart element;
determining, based on the natural language query or the selection of the chart element, contextual metadata from an associative engine, wherein the contextual metadata comprises at least one of current selection state, hypercube data, data model relationships, or user interaction history;
generating, based on the contextual metadata and one or more insight templates, a prompt for a large language model, wherein the one or more insight templates are incorporated as components within the prompt rather than as direct output;
causing, based on the prompt, the large language model to generate a natural language insight response that combines factual content from the contextual metadata with flexible narrative generation; and
causing, based on the natural language insight response, the natural language insight response to be output at the user interface.

2. The method of claim 1, wherein the associative engine operates in-memory and provides sub-second response times for retrieving the contextual metadata.

3. The method of claim 1, wherein the contextual metadata further comprises excluded data values that are not associated with current user selections.

4. The method of claim 3, wherein the natural language insight response includes information about the excluded data values to provide comprehensive analytical context.

5. The method of claim 1, further comprising:
generating, based on the prompt, a secondary prompt using a secondary large language model to produce structured draft findings; and
providing the structured draft findings to the large language model for generating the natural language insight response.

6. The method of claim 5, wherein the structured draft findings comprise factual observations and visualization recommendations.

7. The method of claim 1, wherein the one or more insight templates comprise narrative structure patterns and analytical logic rules that guide content generation without dictating specific output format.

8. The method of claim 1, further comprising:
generating, based on the natural language insight response, a visualization specification; and
rendering, based on the visualization specification and data from the associative engine, a chart or graph for display with the natural language insight response.

9. The method of claim 8, wherein the visualization specification is determined by the large language model based on the type of analysis identified in the contextual metadata.

10. The method of claim 1, wherein the selection of the chart element triggers extraction of chart-specific metadata including underlying data points, dimensions, measures, and current filters affecting the chart.

11. A system comprising:
an associative engine configured to store data in-memory and provide contextual metadata comprising current selection states and data relationships;
a prompt construction module configured to generate prompts for a large language model based on user queries and the contextual metadata from the associative engine, wherein insight templates are incorporated as prompt components rather than deterministic output generators;
a large language model configured to process the prompts and generate natural language insights that combine template-derived facts with flexible narrative generation; and
a user interface configured to receive user interactions and display the natural language insights generated by the large language model.

12. The system of claim 11, wherein the associative engine is further configured to provide excluded data values that are not associated with current user selections, enabling the large language model to generate insights about data relationships beyond filtered results.

13. The system of claim 11, further comprising a secondary large language model configured to generate structured draft findings based on the prompts, wherein the large language model processes the structured draft findings to produce the natural language insights.

14. The system of claim 13, wherein the structured draft findings comprise factual observations, key statistics, and visualization recommendations that guide the large language model in generating contextually relevant narratives.

15. The system of claim 11, further comprising a visualization rendering module configured to generate charts or graphs based on visualization specifications provided by the large language model and data retrieved from the associative engine.

16. A method comprising:
receiving, based on a user selection of a visualization element in a user interface, a request for insight generation about the selected visualization element;
determining, based on the selected visualization element, chart metadata and underlying data from an associative engine operating in-memory;
generating, based on the chart metadata and underlying data, a structured prompt for a large language model, wherein the structured prompt includes contextual information about the visualization and template-based analytical findings as prompt components;
causing, based on the structured prompt, the large language model to generate a natural language explanation of the selected visualization element; and
causing, based on the natural language explanation, the natural language explanation to be output at the user interface alongside the selected visualization element.

17. The method of claim 16, wherein the chart metadata comprises chart type, data dimensions, measures, and current filters applied to the selected visualization element.

18. The method of claim 17, wherein the underlying data comprises historical comparison data and statistical measures that provide context for the selected visualization element.

19. The method of claim 18, wherein the natural language explanation includes identification of anomalies or patterns in the underlying data that are relevant to the selected visualization element.

20. The method of claim 16, wherein the template-based analytical findings comprise pre-computed statistical analyses and trend identifications that are incorporated as factual components within the structured prompt.
